(19) United States
(12) Patent Application Publication
(10) Pub. No.: US 2025/0070705 A1
(43) Pub. Date: Feb. 27, 2025

(54) Portable Solar Energy Capturing System

(71) Applicants: John Strisower, Woodinville, WA (US); Kilows, inc., Bothell, WA (US)

(72) Inventor: John Strisower, Woodinville, WA (US)

(21) Appl. No.: 18/815,461

(22) Filed: Aug. 26, 2024

Related U.S. Application Data
(60) Provisional application No. 63/578,486, filed on Aug. 24, 2023.

(51) Int. Cl. H02S 10/40; H02S 20/30; H02S 30/20; H02S 40/10

(52) U.S. Cl. CPC H02S 10/40; H02S 20/30; H02S 30/20; H02S 40/10

(57) ABSTRACT

A portable solar-energy capturing system is an array device intended to provide a portable and mobile solar panel that attaches to trailers, shipping containers, or of the likes. More specifically, the system is a solar panel array that is compact and is stackable on top of one another. Further, the device includes an integrated corner casting mechanism to assist the fastening points of the array frame onto trailers of a vehicle, shipping containers, or of the likes. Furthermore, the system is easily maneuverable and can be easily set up like a foldable table. Additionally, the device includes a water catchment system and a water circulating system that allows for rainwater capturing and cleaning of the solar panel and/or solar farm. Thus, the device is a portable and easily maneuverable solar-energy catchment system that may be set up at different locations as a temporary or permanent solar farm.

The current application claims a priority to the U.S. provisional patent application Ser. No. 63/578,486 filed on Aug. 24, 2023. The current application is filed on Aug. 26, 2024, while Aug. 24, 2024 was on a weekend.

### FIELD OF THE INVENTION

The present invention relates to solar panels. More specifically, the present invention relates to a portable and mobile solar energy capturing system, that may be attached to container roofs and/or temporary ground mount applications.

### BACKGROUND OF THE INVENTION

There are many ways to harvest renewable energy. The most popular method of harvesting renewable energy is capturing sunlight by means of using solar panels. Solar panels are panels designed to absorb sunlight as a source of energy for generating electricity or heating. Solar panels are well accustomed throughout the world as they provide a method of harvesting energy directly from the sun. In most cases, solar panels are simply placed in open locations which are directly open to sunlight with no blockage. For example, solar panels are placed on houses and buildings with no blockage of sunlight within the surroundings. Though the application of solar panels does appear in different areas of the world, there can be inefficient methods of capturing solar energy. These inefficient methods may not be used to their potential and may be disadvantageous for the users.

An objective of the present invention is to provide a portable and mobile solar array device that attaches to trailers, shipping containers, or of the likes. More specifically, the present invention is a solar panel that is compact as it is stackable on top of one another and may be easily set up on different terrains. Further, the present invention may be attached on the top surface of trailers of a vehicle in a secure manner. Furthermore, the present invention is easily maneuverable and may be easily set up like a foldable table. Additionally, the present invention comprises a water catchment system and a water circulating system that allows for rainwater capturing and cleaning of the solar panel and/or temporary solar farms.

### SUMMARY OF THE INVENTION

The present invention is intended to provide a portable and mobile solar panel that attaches to trailers, shipping containers, or of the likes. More specifically, the present invention is a solar energy capturing device that is compact and is stackable on top of one another. Further, the present invention may be attached on the top surface of trailers of a vehicle in a secure manner. To that end, the present invention comprises an integrated corner casting mechanism to assist the fastening points of the panel onto trailers of a vehicle, shipping containers, or of the likes. Furthermore, the present invention is easily maneuverable and may be easily set up like a foldable table. Additionally, the present invention comprises a water catchment system and a water circulating system that allows for rainwater capturing and cleaning of the solar panel and/or solar farm. Thus, the present invention is a portable and easily maneuverable solar panel device, that may be easily set up on different locations as a temporary or permanent solar farm.

### BRIEF DESCRIPTION OF THE DRAWINGS

FIG. 1 is a top-front-left perspective view of a preferred embodiment of the present invention.

FIG. 2 is an illustration of the present invention, wherein a plurality of solar array devices is arranged in a stacked configuration.

FIG. 3 is an illustration of the tabletop embodiment of the present invention.

FIG. 4 is an illustration of the shipping container attachment embodiment of the present invention.

FIG. 5 is a top perspective view of the corner casting mechanism.

FIG. 6 is a bottom perspective view of the corner casting mechanism.

FIG. 7 is a perspective view illustrating the tracks and sliding features of the present invention.

FIG. 8 is a sectional view of a twist lock being connected to two corner casting devices.

FIG. 9 is a perspective view of a solar farm made from a plurality of solar array devices.

FIG. 10 is a system diagram of a water circulation system according to the present invention.

### DETAILED DESCRIPTION OF THE INVENTION

All illustrations of the drawings are for the purpose of describing selected versions of the present invention and are not intended to limit the scope of the present invention.

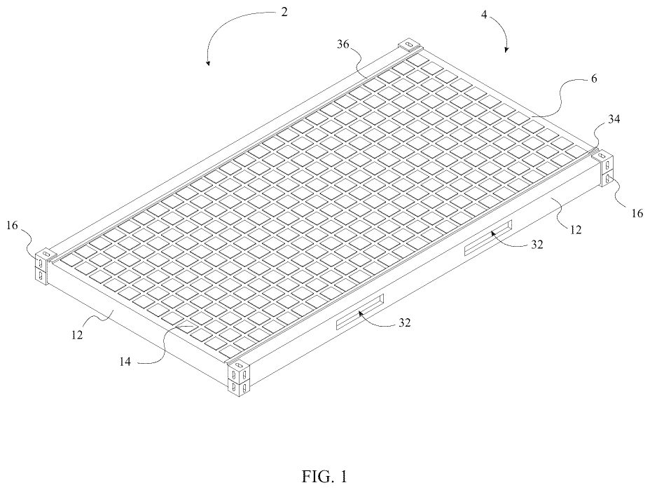

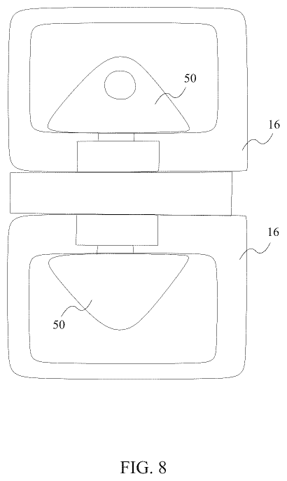

In reference to FIG. 1 through FIG. 10, the present invention provides a portable and mobile solar panel that attaches to trailers, shipping containers, or of the like. The following description is in reference to FIG. 1 through FIG. 10. According to a preferred embodiment, the present invention comprises at least one array device 2, wherein the at least one array device 2 comprises an array frame 4, at least one solar panel 14, a plurality of corner casting devices 16, and a plurality of slots 32. The array frame 4 is a large rectangular board that can attach to the top surface of trailers of a vehicle. In addition, the array frame 4 can attach to the exterior surfaces of a shipping container. In the preferred embodiment, the array frame 4 is a rectangular cuboid. More specifically, the array frame 4 comprises a frame platform 6 and a plurality of side walls 12. As seen in FIG. 1, the plurality of side walls 12 is perimetrically mounted about the array platform. Preferably the frame platform 6 and the plurality of side walls 12 are made of a sturdy material such as steel. However, the array frame 4 may comprise any other material, dimensions, components, arrangement of components, etc. that are known to one of ordinary skill in the art, as long as the intents of the present invention are fulfilled.

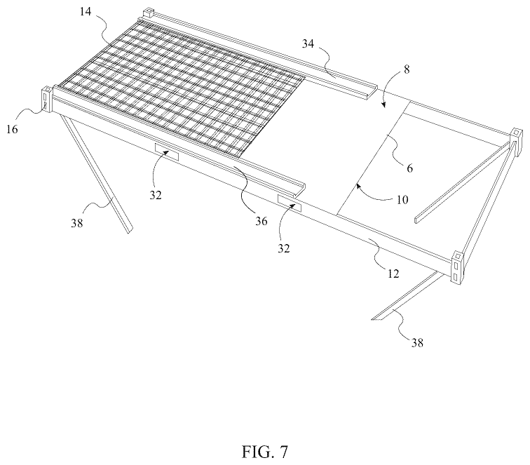

The array frame 4 is used as the housing apparatus for the insertion of the solar panel as can be seen in FIG. 7. To that end, the frame platform 6 comprises a first platform surface 8 and a second platform surface 10, wherein the first platform surface 8 and the second platform surface 10 are positioned opposite to each other about the frame platform 6. In the preferred embodiment, the at least one solar panel 14 is mounted onto the first array surface. Further, the plurality of side walls 12 is oriented away from the first platform surface 8. In reference to FIG. 1, the at least one solar panel 14 is a single panel made of a plurality of solar cells. The at least one solar panel 14 is a rectangular board designed to absorb sunlight as a source of energy for generating usable energy such as electricity. In other words, and as seen in FIG. 1 through FIG. 3, on a top surface of the array frame 4, small square solar panels or solar cells are evenly distributed and spread across.

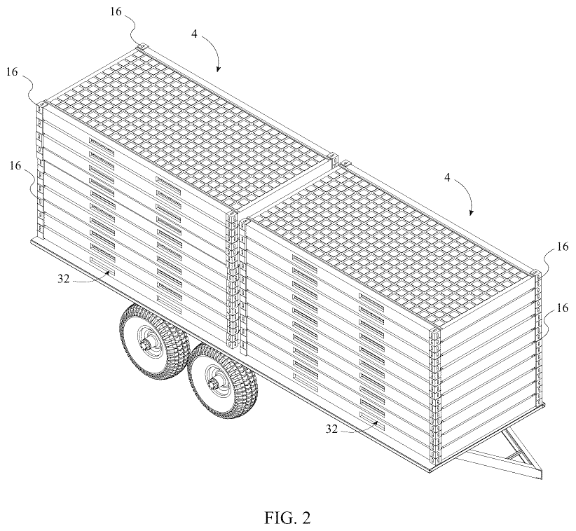

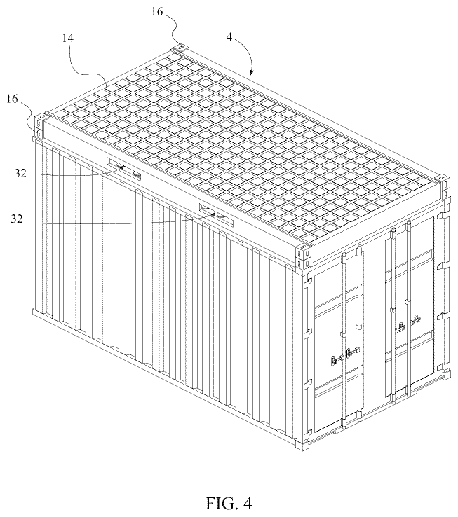

According to the preferred embodiment, the attachment of the array frame 4 to other equipment and machinery is made possible by means of the plurality of corner casting devices 16. To that end, each of the plurality of corner casting devices 16 is mounted into a corresponding corner between two adjacent side walls from the plurality of side walls 12. Preferably, the four corners of the array frame 4 comprise welded stacked corner casting pairs. In other words, a pair of corner casting devices from the plurality of corner casting devices 16 is mounted into the corresponding corner. More specifically, the plurality of corner casting devices 16 is used to enable fastening of the array frame 4 onto other surfaces such as the top surface of a trailer or a shipping container as shown in FIG. 2 and FIG. 4.

Continuing with the preferred embodiment, the plurality of slots 32 laterally traverses through the plurality of side walls 12. In other words, on the long edge of the frame, there exist rectangular apertures or the plurality of slots 32 that traverse laterally through the array frame 4. The plurality of slots 32 is centered and aligned evenly from the edges. The plurality of slots 32 is utilized as a mechanism to allow forklifts to lift and transport the frame. More specifically, the plurality of slots 32 is essentially forklifting pockets to allow the insertion of forks on a forklift.

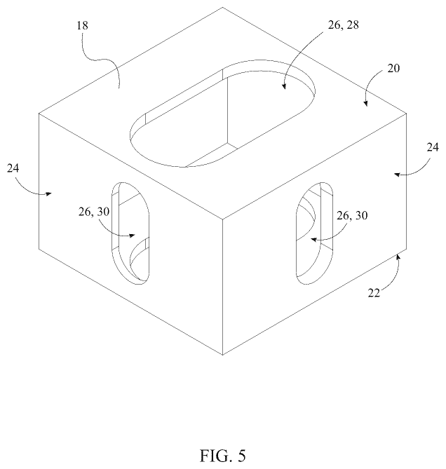

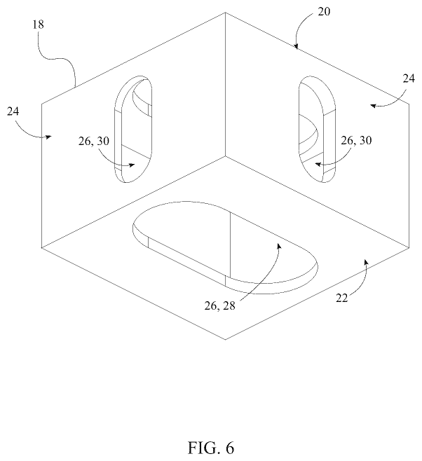

A more detailed description of the present invention is as follows. According to the preferred embodiment, each of the plurality of corner casting devices 16 comprises a cuboid body 18 and a plurality of holes 26, wherein the plurality of holes 26 traverses through the cuboid body 18. In reference to FIG. 5 and FIG. 6, a corner casting device is shown. The corner casting device is the small fastening device used to alter the present invention into different embodiments. As seen in FIG. 5 and FIG. 6, the cuboid body 18 may comprise a first base surface 20, a second base surface 22, and a plurality of lateral surfaces 24. Preferably, the first base surface 20 is positioned opposite to the second base surface 22 about the cuboid body 18. Further, the plurality of holes 26 may comprise a vertical hole 28 and at least one horizontal hole 30, wherein the vertical hole 28 traverses normally through the first base surface 20 and the second base surface 22. Furthermore, the at least one horizontal hole 30 traverses normal through two opposing lateral surfaces from the plurality of lateral surfaces 24. As seen in FIG. 5 and FIG. 6, each of the plurality of holes 26 may have a stadium shape, wherein an area of the vertical hole 28 is greater than an area of the at least one horizontal hole 30.

According to the preferred embodiment, the at least one array device 2 further comprises a first lengthwise track 34 and a second lengthwise track 36. Preferably, the first lengthwise track 34 and the second lengthwise track is used as a fastening mechanism for the panels as can be seen in FIG. 7. In other words, the tracks allow for solar panels to slide and fasten onto the top surface of the frame. Preferably, the first lengthwise track 34 and the second lengthwise track 36 are positioned parallel to each other, and the first lengthwise track 34 and the second lengthwise track 36 are positioned opposite to each other across the frame platform 6. As seen in FIG. 1, and FIG. 7, the first lengthwise track 34 and the second lengthwise track 36 are mounted onto the first platform surface 8, and the at least one solar panel 14 is slidably engaged along the first lengthwise track 34 and the second lengthwise track 36.

In an alternate embodiment, instead of sliding in smaller commercial solar panels into the array frame 4, solar cells may be implanted onto the first platform surface 8 to form a big single solar panel.

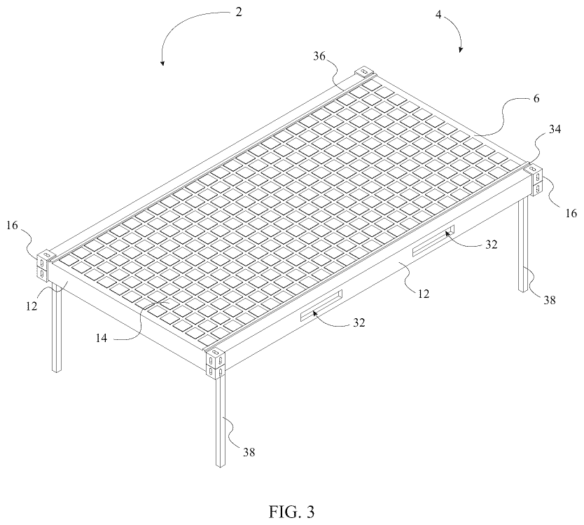

It is an aim of the present invention, to enable easy maneuverability and easy setup. To accomplish this, the present invention comprises a set of legs that enables the present invention to be set up like a foldable table. In other words, the at least one array device 2 may further comprise a plurality of legs 38, wherein the plurality of legs 38 is peripherally distributed about the frame platform 6. As can be seen in FIG. 3, the plurality of legs 38 is utilized as an optional bottom support for the panel. The plurality of legs 38 may be attached to the bottom corners of the array frame 4 by means of using each of the plurality of corner casting devices 16 on each corner. Further, the plurality of legs 38 can alter the array device into structures similar to a deployed foldable table. To that end, each of the plurality of legs 38 is hingedly connected to the second platform surface 10, and each of the plurality of legs 38 is positioned adjacent to a corresponding corner between two adjacent side walls from the plurality of side walls 12. In the preferred embodiment, the frame platform 6 is a flat sheet of diamond steel that provides rigidity for the array frame 4 and simultaneously prevents high spots in uneven surfaces from damaging the underside of the solar panels mounted in the array frame 4.

According to the preferred embodiment, the connections near each of the four corners on the short ends of the array frame 4 are used for the connection of multiple frames. More specifically, the connections may be serial or parallel depending on the desired configuration/set-up. In reference to FIG. 1 through FIG. 10, different embodiments and/or deployments of the present invention are shown. More specifically, the present invention can be deployed onto the top surface of a trailer as illustrated in FIG. 2. In addition, the present invention may be deployed onto the surface of a shipping container as illustrated in FIG. 4. The present invention can provide power to any connected device, machinery, equipment, apparatus, etc. In practical use, the present invention is used as a portable solar panel that is easily set-up and utilized for electrical energy/power. In addition, the present invention can be set up onto a trailer to provide and store power that can be used later. The present invention can also be attached to shipping containers as a unique method for harvesting sunlight and converting it to electrical energy/power. An example of real-life application, the present invention connected and fastened to an intermodal (ISO) container will provide integration with battery and heat pump refrigeration for refrigerated containers. Note that ISO containers can be moved with the present invention installed. The container can be lifted by the present invention with the twist locks properly installed.

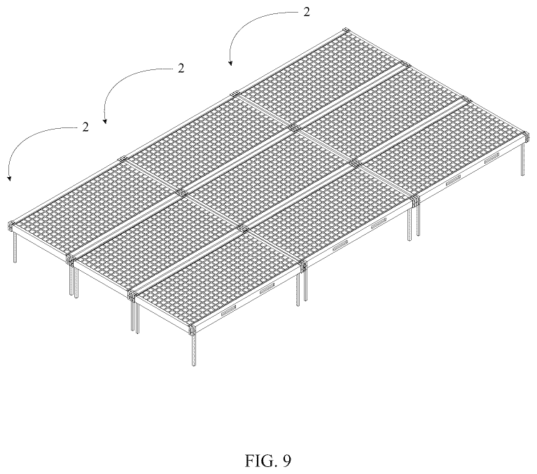

In an alternate embodiment, helical piling heads with 1, 2, or 4 oval slots that can accept corner casting twist locks may be used for mounting the solar panels in various terrains and thus building a temporary solar farm. For example, after helical pilings are driven into the ground, then a single slot or double slot or quad slot head (depending on how many array frames are being connected to one helical piling) can be attached to the helical piling to allow solar array(s) to be mounted using twist locks. To that end, the present invention may comprise a plurality of twist locks 50. Further, the at least one array device 2 is a plurality of array devices. Accordingly, in such embodiments, each of the plurality of corner casting devices 16 of an arbitrary array device is attached onto a corresponding corner casting device from the plurality of corner casting devices 16 of an adjacent array device by a single twist lock from the plurality of twist locks 50, wherein the arbitrary array device and the adjacent array device are any adjacent pair of array devices from the plurality of array devices. In reference to FIG. 2, the plurality of array frames is arranged in a stacked configuration. Furthermore, in reference to FIG. 9, the plurality of array frames is arranged in a side-by-side configuration. As seen in FIG. 9, the plurality of array frames or such solar arrays may be arranged to create a solar farm.

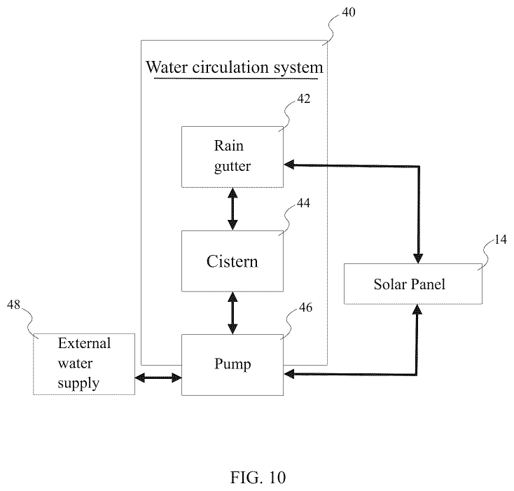

In reference to FIG. 10, the present invention may comprise at least one water circulation system 40. Preferably, the at least one water circulation system 40 is operably integrated to the at least one array device 2, wherein the at least one water circulation system 40 is used to circulate water on the at least one solar panel 14 and is used to catch water falling on the at least one solar panel 14. To accomplish this, the at least one water circulation system 40 may comprise a rain gutter 42, a cistern 44, a water pump 46, and an external water supply 48. Preferably, the rain gutter 42 is perimetrically mounted along the plurality of side walls 12. More specifically, each of the long edges of the array frame 4 may comprise an integrated and concealed rain gutter 42. The rain gutter 42 is utilized for capturing liquid such as rainwater for subsequent use and/or impervious surface runoff mitigation. In other words, an upper section of the array frame 4 may comprise a rain catchment system that drains any liquid to the corners. Liquid in contact with the top surface of the frame will drain into cistern 44 or a drainage system. Thus, the water collected in the water collecting container may be connected to the water pump 46 for circulation or a drainage system. Accordingly, the cistern 44 and the water pump 46 are detachably mounted to the rain gutter 42, and the cistern 44, the water pump 46, the external water supply 48, and the rain gutter 42 are in fluid communication with each other. Additionally, the rain gutter 42 may be integrated into the first lengthwise track 34 and the second lengthwise track 36 in an extended and/or concealed fashion.

Although the invention has been explained in relation to its preferred embodiment, it is to be understood that many other possible modifications and variations can be made without departing from the spirit and scope of the invention as hereinafter claimed.

What is claimed is:

1. A portable solar-energy capturing system comprising:
at least one array device;
the at least one array device comprising an array frame, at least one solar panel, a plurality of corner casting devices, and a plurality of slots;
the array frame comprising a frame platform and a plurality of side walls;
the frame platform comprising a first platform surface and a second platform surface;
the first platform surface and the second platform surface being positioned opposite to each other about the array platform;
the plurality of slots laterally traversing through the plurality of side walls;
the at least one solar panel being mounted onto the first array surface;
the plurality of side walls being perimetrically mounted about the array platform;
the plurality of side walls being oriented away from the first platform surface; and
each of the plurality of corner casting devices being mounted into a corresponding corner between two adjacent side walls from the plurality of side walls.

2. The portable solar-energy capturing system of claim 1, wherein the array frame is a rectangular cuboid.

3. The portable solar-energy capturing system of claim 1, wherein a pair of corner casting devices from the plurality of corner casting devices is mounted into the corresponding corner.

4. The portable solar-energy capturing system of claim 1 further comprising:
each of the plurality of corner casting devices comprising a cuboid body and a plurality of holes; and
the plurality of holes traversing through the cuboid body.

5. The portable solar-energy capturing system of claim 4 further comprising:
the cuboid body comprising a first base surface, a second base surface, and a plurality of lateral surfaces;
the plurality of holes comprising a vertical hole and at least one horizontal hole;
the first base surface being positioned opposite to the second base surface about the cuboid body;
the vertical hole traversing normal through the first base surface and the second cuboid surface; and
the at least one horizontal hole traversing normal through two opposing lateral surfaces from the plurality of lateral surfaces.

6. The portable solar-energy capturing system of claim 5 further comprising:
each of the plurality of holes being a stadium shape; and
an area of the vertical hole being greater than an area of the at least one horizontal hole.

7. The portable solar-energy capturing system of claim 1 further comprising:
the at least one array device further comprising a first lengthwise track and a second lengthwise track;
the first lengthwise track and the second lengthwise track being positioned parallel to each other;
the first lengthwise track and the second lengthwise track being positioned opposite to each other across the frame platform;
the first lengthwise track and the second lengthwise track being mounted onto the first platform surface; and
the at least one solar panel being slidably engaged along the first lengthwise track and the second lengthwise track.

8. The portable solar-energy capturing system of claim 1 comprising:
the at least one array device further comprising a plurality of legs;
the plurality of legs being peripherally distributed about the frame platform;
each of the plurality of legs being hingedly connected to the second platform surface; and
each of the plurality of legs being positioned adjacent to a corresponding corner between two adjacent side walls from the plurality of side walls.

9. The portable solar-energy capturing system of claim 1 further comprising:
a plurality of twist locks;
the at least one array devices being a plurality of array devices; and
each of the plurality of corner casting devices of an arbitrary array device being attached onto a corresponding corner casting device from the plurality of corner casting devices of an adjacent array device by a single twist lock from the plurality of twist locks, wherein the arbitrary array device and the adjacent array device are any adjacent pair of array devices from the plurality of array devices.

10. The portable solar-energy capturing system of claim 9, wherein the plurality of array frames is arranged in a stacked configuration.

11. The portable solar-energy capturing system of claim 9, wherein the plurality of array frames is arranged in a side-by-side configuration.

12. The portable solar-energy capturing system of claim 1 further comprising:
at least one water circulation system; and
the at least one water circulation system being operably integrated to the at least one array device, wherein the at least one water circulation system is used to circulate water on the at least one solar panel and is used to catch water falling on the at least one solar panel.

13. The portable solar-energy capturing system of claim 12 further comprising:
the at least one water circulation system comprising a rain gutter, a cistern, a water pump, and an external water supply;
the rain gutter being perimetrically mounted along the plurality of side walls;
the cistern and the water pump being detachably mounted to the rain gutter; and
the cistern, the water pump, the external water supply, and the rain gutter being in fluid communication with each other.

14. A portable solar-energy capturing system comprising:
at least one array device;
the at least one array device comprising an array frame, at least one solar panel, a plurality of corner casting devices, a plurality of slots, and a plurality of legs;
the array frame comprising a frame platform and a plurality of side walls;
the frame platform comprising a first platform surface and a second platform surface;
the first platform surface and the second platform surface being positioned opposite to each other about the array platform;
the plurality of slots laterally traversing through the plurality of side walls;
the at least one solar panel being mounted onto the first array surface;
the plurality of side walls being perimetrically mounted about the array platform;
the plurality of side walls being oriented away from the first platform surface;
each of the plurality of corner casting devices being mounted into a corresponding corner between two adjacent side walls from the plurality of side walls;
the array frame being a rectangular cuboid;
the plurality of legs being peripherally distributed about the frame platform;
each of the plurality of legs being hingedly connected to the second platform surface; and
each of the plurality of legs being positioned adjacent to a corresponding corner between two adjacent side walls from the plurality of side walls.

15. The portable solar-energy capturing system of claim 14, wherein a pair of corner casting devices from the plurality of corner casting devices is mounted into the corresponding corner.

16. The portable solar-energy capturing system of claim 14 further comprising:
each of the plurality of corner casting devices comprising a cuboid body and a plurality of holes;
the cuboid body comprising a first base surface, a second base surface, and a plurality of lateral surfaces;
the plurality of holes comprising a vertical hole and at least one horizontal hole;
the plurality of holes traversing through the cuboid body;
the first base surface being positioned opposite to the second base surface about the cuboid body;
the vertical hole traversing normal through the first base surface and the second cuboid surface;
the at least one horizontal hole traversing normal through two opposing lateral surfaces from the plurality of lateral surfaces;
each of the plurality of holes being a stadium shape; and
an area of the vertical hole being greater than an area of the at least one horizontal hole.

17. The portable solar-energy capturing system of claim 14 further comprising:
the at least one array device further comprising a first lengthwise track and a second lengthwise track;
the first lengthwise track and the second lengthwise track being positioned parallel to each other;
the first lengthwise track and the second lengthwise track being positioned opposite to each other across the frame platform;
the first lengthwise track and the second lengthwise track being mounted onto the first platform surface; and
the at least one solar panel being slidably engaged along the first lengthwise track and the second lengthwise track.

18. The portable solar-energy capturing system of claim 14 further comprising:
a plurality of twist locks;
the at least one array devices being a plurality of array devices; and
each of the plurality of corner casting devices of an arbitrary array device being attached onto a corresponding corner casting device from the plurality of corner casting devices of an adjacent array device by a single twist lock from the plurality of twist locks, wherein the arbitrary array device and the adjacent array device are any adjacent pair of array devices from the plurality of array devices.

19. The portable solar-energy capturing system of claim 18, wherein the plurality of array frames is arranged in a stacked configuration or a side-by-side configuration.

20. The portable solar-energy capturing system of claim 14 further comprising:
at least one water circulation system;
the at least one water circulation system comprising a rain gutter, a cistern, a water pump, and an external water supply;
the at least one water circulation system being operably integrated to the at least one array device, wherein the at least one water circulation system is used to circulate water on the at least one solar panel and is used to catch water falling on the at least one solar panel;
the rain gutter being perimetrically mounted along the plurality of side walls;
the cistern and the water pump being detachably mounted to the rain gutter; and
the cistern, the water pump, the external water supply, and the rain gutter being in fluid communication with each other.
